(19) United States
(12) Patent Application Publication
(10) Pub. No.: US 2007/0082197 A1
(43) Pub. Date: Apr. 12, 2007

(54) Electrospun carbon nanotube reinforced silk fibers

(76) Inventors: Frank K. Ko, Philadelphia, PA (US); Sachiko Sukigara, Niigata (JP); Milind Gandhi, Philadelphia, PA (US); Jonathan Ayutsede, Philadelphia, PA (US)

Correspondence Address: LICATA & TYRRELL P.C., 66 E. MAIN STREET, MARLTON, NJ, 08053, US

(21) Appl. No.: 10/577,709

(22) PCT Filed: Nov. 4, 2004
(86) PCT No.: PCT/US04/37076

§ 371 Date: Aug. 18, 2006

Related U.S. Application Data
(60) Provisional application No. 60/517,128, filed on Nov. 4, 2003.

(51) Int. Cl. B32B 9/00

(52) U.S. Cl. 428/367; 977/904

(57) ABSTRACT

Strong and tough synthetic fibrils of carbon nanotube and spider silk are provided. Methods for production of these synthetic fibrils and methods for their use in biomedical devices, including those requiring electroconductivity, and areas of blast and ballistic protection are also provided.

### FIELD OF THE INVENTION

The present invention relates to synthetic fibrils comprised of carbon nanotube and spider or silkworm silk and methods for their production by electrospinning. These fibrils exhibit enhanced strength and toughness as compared to spider silk or silkworm silk alone and are useful biomedically as surgical implants, sutures, tissue engineering scaffolds and drug delivery agents. The electroconductive properties of these fibrils renders them useful as electrodes for brain/machine interfaces and neuron regeneration as well. The strength and toughness of these fibers also renders them useful in areas of blast and ballistic protection.

### BACKGROUND OF THE INVENTION

In spite of the progress made over the past century in polymeric fiber science and technologies, the search for a truly strong and tough fiber continues. It is of practical and scientific interest to explore the limit of strength and toughness of fibrous materials; and to examine the factors that contribute to the development of a combination of strength and toughness in materials. There is an urgent need for light weight fibrous materials that have high level of combined strength and toughness in light of the increasing need for higher level of ballistic protection for the nation's security providers and warriors.

Strength and toughness are usually considered mutually exclusive properties for materials.

In the world of natural fibers, spider silk has long been recognized as the wonder fiber for its unique combination of high strength and rupture elongation. Spider silk has been shown to have a strength as high as 1.75 GPa at a breaking elongation of over 26% (Ko F. K. et al. Engineering properties of spider silk. Proceedings, MRS Annual Meeting, 2001). This gives rise to a toughness level of two to three times of that of aramid and other industrial fibers.

The toughness property of fibers is an indication of the ability of a fiber to absorb impact energy. In a recent study on composite armors systems, it was shown, in terms of the Florence model that the residual velocity of projectile is directly related to the toughness of the backing materials (Ko et al. MURI Final Report to US Army Research Office, DAAH 04-96-1-0018, 1997-2002). Compared to the state of the art strong fibers, it was shown that spider silk-backed armor provided the highest specific V₅₀ or resistance to ballistic penetration.

As the threat for personnel armors is being expanded to include hand guns (9 mm) and small arms (7.62 mm) the demand for improvement of ballistic performance and areal densities is greater. The ballistic limit of the armor system is expected to exceed 1000 m/s at an areal density of less than 3.5 lb/ft². At these threat levels, only the spider silk based armor backing comes close to meeting the requirement. However, in spite of its exciting toughness characteristics, spider silk remains a curiosity rather than a serious engineering materials. This is largely due to the lack of a practical method to harvest spider silk in quantity.

Recently, transgenic synthesis of spider silk polymer has made large scale manufacturing of spider silk possible (Lazaris A. et al. Science 2002 295:472-476). In this process, recombinant spider silk, BIOSTEEL® in BELE® (Breed Early Lactate Early) goat system, was produced in combination with pronuclear microinjection and nuclear transfer technologies resulting in a scalable manufacturing process for spider silk. While the biotechnology pathway to large scale manufacturing of spider silk is promising, the strength of the synthetic silk is far from satisfactory in spite of its high level of elongation at break.

### SUMMARY OF THE INVENTION

It has now been found that carbon nanotube is an ideal reinforcing material to strengthen synthetic spider silk and silkworm silk.

Accordingly, an object of the invention is to provide a synthetic fibril comprising carbon nanotube and spider silk or silkworm silk.

Another object of the present invention is to provide a method for producing strong and tough fibrils that comprises electrospinning carbon nanotube with spider silk or silkworm silk into single fibrils.

### DETAILED DESCRIPTION OF THE INVENTION

While recombinant techniques have made possible production of synthetic spider silk and silkworm silk in large quantities, these synthetic silks exhibit decreased strength. Carbon nanotube exhibits a Young's modulus of 1 TPa and a strength of 30-60 GPa at elongation at break ranging from 6-30%. Thus, carbon nanotube provides an ideal reinforcing material to strengthen synthetic spider silk and silkworm silk.

The present invention provides compositions and methods for producing stronger, tougher fibrils comprising spider silk or silkworm silk and carbon nanotube. In a preferred embodiment, to maximize the reinforcement effect of the carbon nanotube, fibrils of the present invention are prepared via an electrospinning process.

In the electrospinning process an electric field is generated between an oppositely charged polymer fluid and a fiber collection ground plate. A polymer solution is added to a glass syringe with a capillary tip. As the electrical potential is increased, the charged polymer solution is attracted to the screen. Once the voltage reaches a critical value, the charge overcomes the surface tension of the polymer cone formed on the capillary tip of the syringe and a jet of ultra fine fibers is produced. As the charged fibers are splayed, the solvent quickly evaporates and the solidified fibers are accumulated randomly on the surface of the collection screen. This results in a nonwoven mesh of nano to micron scale fibers. Varying charge density, polymer solution concentration and the duration of electrospinning can control fiber diameter and mesh thickness.

Experiments have been performed on electrospun fibrils of single walled carbon nanotube ranging from 1% to 5% by weight in a polyacrylonitrile (PAN) matrix (Adv. Mater. 2003 15(14):1161-1165). These fibrils are referred to herein as CNT/PAN composite fibrils.

In particular, the elastic properties of the CNT/PAN composite fibril were tested in an Atomic Force Microscope (AFM) using a taping mode. The elastic moduli of the fibrils were evaluated based upon procedures such as described by Kracke and Damaschke (Appl. Phys. Lett. 2000 77:361-363). It was found that the Young's modulus of the CNT/PAN and PAN fibrils is a function of carbon nanotube volume fraction. Specifically, a 4.5 fold, increase in volume fraction effect by the introduction of less than 1.5%. by volume of carbon nanotube to the PAN matrix.

Thus, it is believed that addition of carbon nanotube, with its superior strength and modulus characteristics, will greatly enhance the strength of synthetic spider silk and silkworm silk.

Further, it is believed that the respective deformation characteristics of synthetic spider silk or silkworm silk and carbon nanotube are compatible. For example, it has been postulated that the most effective use of the tensile properties of two materials in a combined system is to have compatible elongation at break. The theory of elongation balance is well known in textile design (Ko, F. K., Krauland, K., and Scardino, F., “Weft Insertion Warp Knit for Hybrid Composites,” Progress in Science and Engineering of Composites, eds. Hayashi et al., ICCM-V, Fourth International Conference on Composites, 1982, p. 982) and in composite analysis (ACK theory; Averston, J. Cooper, G., Kelly, A., In Properties of Fiber Composites. Conf. Proc. National Physical Laboratory, Guildford, UK:IPC. P. 15). On the basis of elongation balance spider silk (20-30% elongation at break) and carbon nanotube (6-30% elongation at break) are among the most compatible material systems of known strong fibers. Thus, it is believed that a natural liquid crystalline polymer such as spider silk along with very small quantity of carbon nanotube, preferably in the range of about 1% to about 10% by weight, can be combined to produce light weight and high strength super fibrils by the electrospinning process.

To produce such fibrils, recombinant spider silk is obtained from commercial sources such as Nexia Biotechnologies. The carbon nanotube are then dispersed in the spider silk polymer solution. In a preferred embodiment, the spider silk solution comprises approximately 8% to about 20% by weight spider silk. In addition, the carbon nanotubes are preferably treated with a surfactant or a dispersion agent so that individual tubes are well separated from each other, approaching the level of mono-dispersion. Such dispersion can be achieved by treating the carbon nanotube with a surfactant or dispersion agent to reduce the surface tension and then thoroughly mix the polymer/carbon nanotube system by sonication. Exemplary dispersion agents or surfactants for use in the present invention include, but are not limited to, polyvinyl pyrrolidone (PVP), polystyrene sulfonate (PSS), polyether, and protein. Once the carbon nanotube are dispersed the spinning dope is ready for electrospinning. The electrostatic charge along with the polymer flow helps in aligning the carbon nanotube in the spider silk polymer matrix.

It is believed that carbon nanotube can also be used to reinforce the strange of silk fibers of Bonbyx mori, more commonly referred to as silkworm. Thus, the present invention is also applicable to silkworm silk.

Parameters for electrospinning including, but not limited to electric field strength, spinning distance and flow rate can be optimized to obtain the desired fiber diameter and concentration. Further, fibers of the present invention can be fabricated into linear assemblies, planar assemblies and/or three-dimensional assemblies as well as into the form of composite structures.

The structure and properties of the nanofiber composite fibrils can then be characterized at the nano/micro level and macro level. At the micro/nano level the surface and geometric properties of the spun composite fibrils are characterized by scanning electron microscopy (SEM), atomic force microscopy (AFM) and transmission electron microscopy (TEM). The mechanical properties of the fibrils are characterized by AFM and by micro-tensile tester to determine the translation of the nano-materials to the bulk structures in yarn and nonwoven assemblies.

The spider or silkworm silk/carbon nanotube fibrils of the present invention are multifunctional materials having not only an unmatched level of combined strength and toughness but also having the function of controlled level of electrical conductivity. The spider or silkworm silk/carbon nanotube fibers are also biocompatible. Thus, the fibers of the present invention are useful in biomedical devices including, but not limited to surgical implants, sutures, tissue engineering scaffolds and drug delivery agents. The finess (nanoscale diameter) and the electrical conductivity also renders them useful as electrodes for brain/machine interfaces and numerous other applications including, but not limited to neuron regeneration. The strength and toughness of these fibers also renders them useful in areas of blast and ballistic protection, for example, in bulletproof vests, armor ceramic tile constrains and cargo explosion constrains.

1. A synthetic fibril comprising carbon nanotube and spider silk or silkworm silk.

2. A method for producing the synthetic fibril of claim 1 comprising electrospinning carbon nanotube with spider silk or silkworm silk into single fibrils.

3. A biomedical device comprising the synthetic fibril of claim 1.

4. A blast or ballistic protection device comprising the synthetic fibril of claim 1.

5. An electroconducting fiber comprising the fibril of claim 1.
